(19) United States
(12) Patent Application Publication
(10) Pub. No.: US 2013/0257847 A1
(43) Pub. Date: Oct. 3, 2013

(54) DISPLAY DEVICE AND IMAGE DATA SIGNAGL OUTPUTTING METHOD THEREOF

(71) Applicant: SAMSUNG ELECTRONICS CO., LTD., Suwon-si (KR)

(72) Inventors: Woo-Nyoung LEE, Seoul (KR); Hyunsang PARK, Seongnam-si (KR); Seong-Young RYU, Seoul (KR)

(73) Assignee: SAMSUNG ELECTRONICS CO., LTD., Suwon-si (KR)

(21) Appl. No.: 13/836,409

(22) Filed: Mar. 15, 2013

(30) Foreign Application Priority Data
Apr. 3, 2012 (KR) 10-2012-0034432

(51) Int. Cl. G09G 5/00

(52) U.S. Cl. CPC G09G 5/00; G09G 3/36
USPC 345/213; 345/92

(57) ABSTRACT

A display device includes a display panel having pixels arranged at intersections of source lines and gate lines, a plurality of source drivers configured to dispersedly output image data signals to the source lines in response to source control signals and a data packet, a plurality of gate drivers configured to drive gate lines in response to gate control signals so as to be connected with pixels corresponding to the source lines, and a timing controller configured to output the data packet, the source control signals, and the gate control signals. At least one of the plurality of source drivers is configured to output carry information associated with an output of the image data signals, and at least another of the plurality of source drivers is configured to output the image data signals in response to the carry information.

### CROSS-REFERENCE TO RELATED APPLICATIONS

This U.S. non-provisional application claims priority under 35 U.S.C §119 from Korean Patent Application No. 10-2012-0034432 filed on Apr. 3, 2012 in the Korean Intellectual Property Office, the entirety of which is incorporated by reference herein.

### BACKGROUND

1. Field

The inventive concepts described herein relate to a display device and an image data signal outputting method.

2. Description of the Related Art

A small-sized and low-power display device may be applied to a notebook computer, an LCD TV, and the like. In particular, an active matrix type liquid crystal display device using a thin film transistor as a switch element may be suitable to display a moving picture.

A liquid crystal display may be formed of a liquid crystal panel, a plurality of source drivers generating a driving voltage for driving a plurality of data lines, and a plurality of gate drivers driving a plurality of gate lines.

### SUMMARY OF THE INVENTION

The present general inventive concept provides a display device to perform a display panel driving operation and a method thereof.

Additional features and utilities of the present general inventive concept will be set forth in part in the description which follows and, in part, will be obvious from the description, or may be learned by practice of the general inventive concept.

The foregoing and other features and utilities of the present general inventive concept may be achieved by providing a display device including a display panel having pixels arranged at intersections of source lines and gate lines, a plurality of source drivers configured to dispersedly output image data signals to the source lines in response to source control signals and a data packet, a plurality of gate drivers configured to drive the gate lines in response to gate control signals so as to be connected with pixels corresponding to the source lines, and a timing controller configured to output the data packet, the source control signals, and the gate control signals. At least one of the plurality of source drivers may be configured to output carry information associated with an output of the image data signals, and at least another of the plurality of source drivers may be configured to output the image data signals in response to the carry information.

Each of the pixels may include a thin film transistor connecting one of the source lines and a pixel node in response to one of the gate control signals, a liquid crystal capacitor connected between the pixel node and a common node and having a liquid crystal layer adjusting a penetration ratio according to a voltage difference, and a storage capacitor connected between the pixel node and the common electrode.

The timing controller may sequentially drive the gate lines.

Each of the plurality of source drivers may sequentially output image data signals.

The at least one source driver may generate the carry information when a last image data signal is output.

Each of the plurality of source drivers may sequentially output the image data signals in response to a clock and sequentially blocks the image data signals in response to a next clock.

The at least one source driver may include a carry information transfer device which generates the carry information to transfer the carry information to the at least another source driver.

The data packet may include a weight value. The plurality of source drivers may receive data packets each having the same weight value, respectively, and output image data signals after performing a count operation corresponding to the weight value.

The data packet may include a weight value. The plurality of source drivers may receive data packets having different weight values and output image data signals after performing a count operation corresponding to a corresponding weight value.

The timing controller may be connected to the plurality of source drivers to transfer the source control signals and the data packet.

Each of the plurality of source drivers may further include a signal information pin receiving directing an output order of the source drivers.

The plurality of gate drivers may be disposed at one side of the display panel.

The plurality of gate drivers may be disposed at one side of the display panel and another side opposite to the one side.

The foregoing and/or other features and utilities of the present general inventive concept may also be achieved by providing an image data signal output method of a display device, the method including dispersedly outputting image data signals to first pixels from a first source driver, generating carry information when image data signals start to be output from the first source driver, and dispersedly outputting image data signals to second pixels from a second source driver in response to the carry information.

The generating carry information may include generating the carry information after a count operation corresponding to a weight value of the first source driver is performed.

The foregoing and/or other features and utilities of the present general inventive concept may also be achieved by providing a computer-readable medium to contain computer-readable codes as a program to execute a method described above or hereinafter.

The foregoing and/or other features and utilities of the present general inventive concept may also be achieved by providing a display device including a display panel and a plurality of drivers each to drive a corresponding different group of pixels of the display panel. One driver may output carry information to an adjacent driver such that the adjacent driver drives the corresponding group of pixels according to the received carry information.

The one driver may drive the corresponding group of pixels of the display panel without using the carry information, and the adjacent driver drives the corresponding group of pixels using the carry information.

The display device may further include one or more gate drivers each to drive a corresponding portion of the different group of pixels of the display panel regardless of the carry information or independent of the carry information.

The display device may further include a timing controller to control the drivers such that a current peak is lowered in driving the display panel.

The foregoing and/or other features and utilities of the present general inventive concept may also be achieved by providing a data processing system including a display device having a display panel and a plurality of drivers each to drive a corresponding different group of pixels of the display panel, wherein one driver may output carry information to an adjacent driver such that the adjacent driver drives the corresponding group of pixels according to the received carry information, and a host controller configured to control the display device with a signal corresponding to the image data signals.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram schematically illustrating a display device according to an embodiment of the inventive concept.

FIG. 2 is a block diagram schematically illustrating a source driver of the display device of FIG. 1.

FIG. 3 is a block diagram schematically illustrating a carry information transfer device of the display device of FIG. 1.

FIG. 4 is a diagram illustrating a timing of an image data signal output from the display device of FIG. 1.

FIG. 5 is a diagram illustrating a data packet output from a timing controller of the display device of FIG. 1 according to an embodiment of the inventive concept.

FIG. 6 is a diagram illustrating a data packet output from a timing controller of the display device of FIG. 1 according to an embodiment of the inventive concept.

FIG. 7 is a diagram schematically illustrating an output shape of an image data signal in a display device of FIG. 1.

FIG. 8 is a block diagram schematically illustrating a display device according to an embodiment of the inventive concept.

FIG. 9 is a block diagram schematically illustrating a display device according to an embodiment of the inventive concept.

FIGS. 10A to 10E are diagrams illustrating output shapes of an image data signal in a display device having a double bank gate according to an embodiment of the inventive concept.

FIG. 11 is a block diagram schematically illustrating a display device according to an embodiment of the inventive concept.

FIG. 12 is a block diagram schematically illustrating a display device according to an embodiment of the inventive concept.

FIG. 13 is a flowchart illustrating a data output method of a display device according to an embodiment of the inventive concept.

FIG. 14 is a block diagram schematically illustrating a data processing system having a display device according to an embodiment of the inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

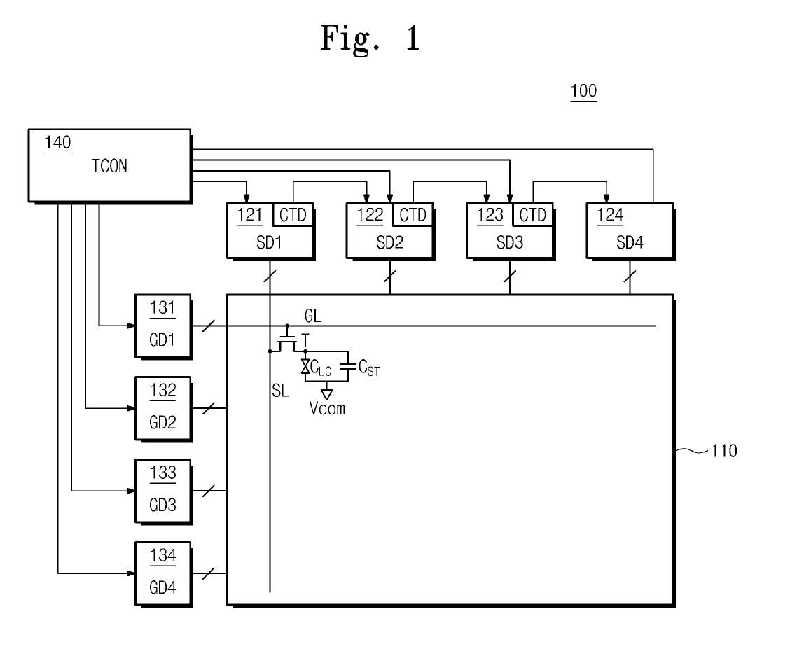

FIG. 1 is a block diagram schematically illustrating a display device 100 according to an embodiment of the inventive concept. Referring to FIG. 1, the display device 100 may include a display panel 110, a plurality of source drivers 121 to 124, a plurality of gate drivers 131 to 134, and a timing controller 140.

The display panel 110 may include a plurality of pixels formed at intersections of gate lines GL and source lines SL. The display panel 110 may be a liquid crystal display panel (LCD), an electrophoretic display panel, an electrowetting display panel, a plasma display panel (PDP), an organic light-emitting diodes (OLED), or the like. For ease of description, it is assumed that the display panel 110 is a liquid crystal display panel.

The plurality of pixels may be arranged in a matrix form within an image display area of the display panel 110. Each pixel may include a thin film transistor T, a storage capacitor Cst, and a liquid crystal capacitor Clc. Each pixel may display read, green, and blue.

Below, a pixel structure will be described using one pixel, for example.

The thin film transistor T may be connected between a source line SL and a pixel node. The thin film transistor T may be driven according to a gate voltage provided to a gate thereof, and may transfer an image data signal of the source line SL to the liquid crystal capacitor C_{LC}. In example embodiments, the thin film transistor T may be fabricated using a low-temperature polysilicon process.

The liquid crystal capacitor C_{LC} may be connected between the pixel node and a common electrode, and may include a liquid crystal layer adjusting a penetration ratio according to a voltage difference therebetween. Herein, the common electrode may be supplied with a common voltage Vcom. In example embodiments, the common voltage Vcom may alternately have two levels in a frame unit, a line unit, or a dot unit according to an inverse driving manner of a liquid crystal display device.

The storage capacitor Cst may be connected between the pixel node and the common electrode.

Although not illustrated, the display panel 110 may include transparent upper and lower substrates. That is, thin film transistors T, gate lines GL, source lines SL, and pixel electrodes for liquid crystal capacitors C_{LC} may be disposed at the lower substrate of the display panel 110. A shield pattern (e.g., a block matrix), a color filter, and a common electrode for liquid crystal capacitor may be disposed at the upper substrate. Herein, the shield pattern may be formed at the remaining area other than a part of the display panel 110, and a liquid crystal layer may exist between the upper substrate and the lower substrate.

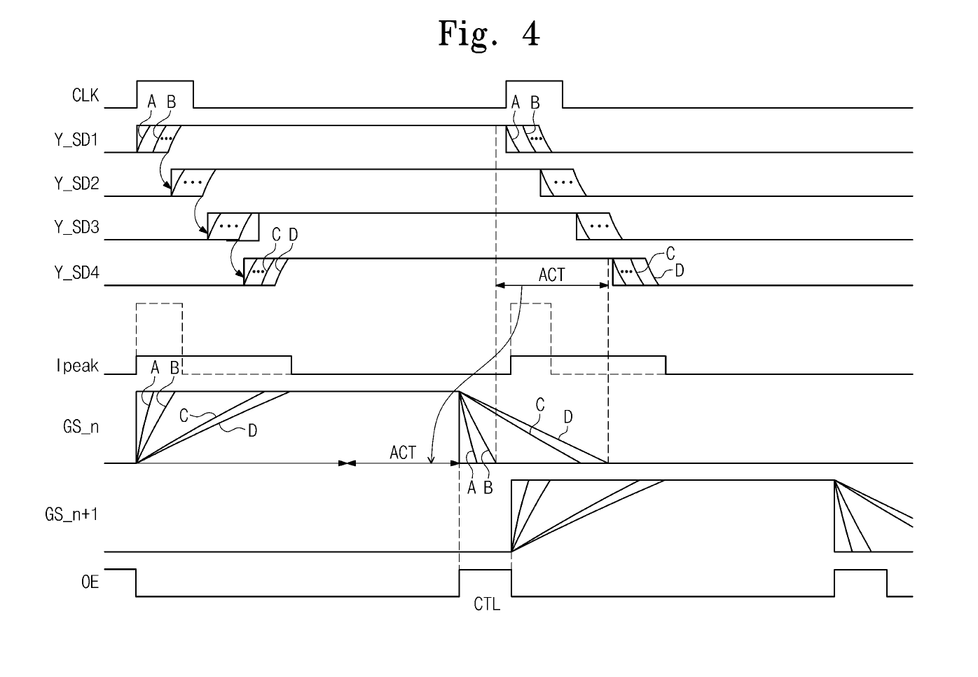

The source drivers 121 to 124 may dispersedly output image data signals (or, referred to as gray scale voltages) corresponding to image data to the display panel 110 through the source lines SL in response to source control signals, respectively. Each of the source drivers 121 to 124 may include a plurality of amplifiers (not shown) for outputting image data signals. Although FIG. 4 illustrates four source drivers are illustrated, the inventive concept is not limited thereto. It is possible that more than four source drivers can be used according to a design or user preference.

Each of the source drivers 121 to 124 may receive a data packet having image data and a source control signal (e.g., a vertical synchronization signal) from the timing controller 140.

At least one of the source drivers 121 to 124 may include a carry information transfer device CTD to transfer carry information to another source driver. Herein, the carry information may be count information associated with an output of image data signals. For example, image data signals may be output after execution of a count operation corresponding to count information, and the carry information may be information indicating that the image data signals start to be output.

At least one of the source drivers 121 to 124 may output an image data signal based on carry information transferred from an adjacent source driver. The gate drivers 131 to 134 may drive the gate lines GL such that image data signals of the source lines SL are sequentially output to the display panel 110. In FIG. 4, four gate drivers may be illustrated. However, the inventive concept is not limited thereto. Each of the gate drivers 131 to 134 may receive a gate control signal (e.g., a horizontal synchronization signal) from the timing controller 140.

The timing controller 140 may receive timing signals (e.g., a vertical synchronization signal, a horizontal synchronization signal, a data enable signal, a clock, etc.) associated with an input frame and image data from an external device, and may output the source control signals for controlling the source drivers 121 to 124, the data packet having image data, and the gate control signals for controlling the gate drivers 131 to 134.

Although not illustrated, the display device 100 may further include a backlight unit for outputting a light to the display panel 110. The backlight unit may include a light source such as a cold cathode fluorescent light (CCFL) or a light emitting diode LED, for example.

A conventional display device may be configured such that output points of time of source drivers are identical to one other. In this case, a peak current may flow. That is, the electromagnetic interface (EMI) may become larger. On the other hand, the display device 100 of the inventive concept may be configured such that output points of time of the source drivers 121 to 124 become different from one another. This may be accomplished by configuring the source drivers 121 to 124 to output image data signals based on carry information of an adjacent source driver. Thus, it is possible to reduce a peak current generated at a data output operation. That is, the electromagnetic interface (EMI) may be reduced.

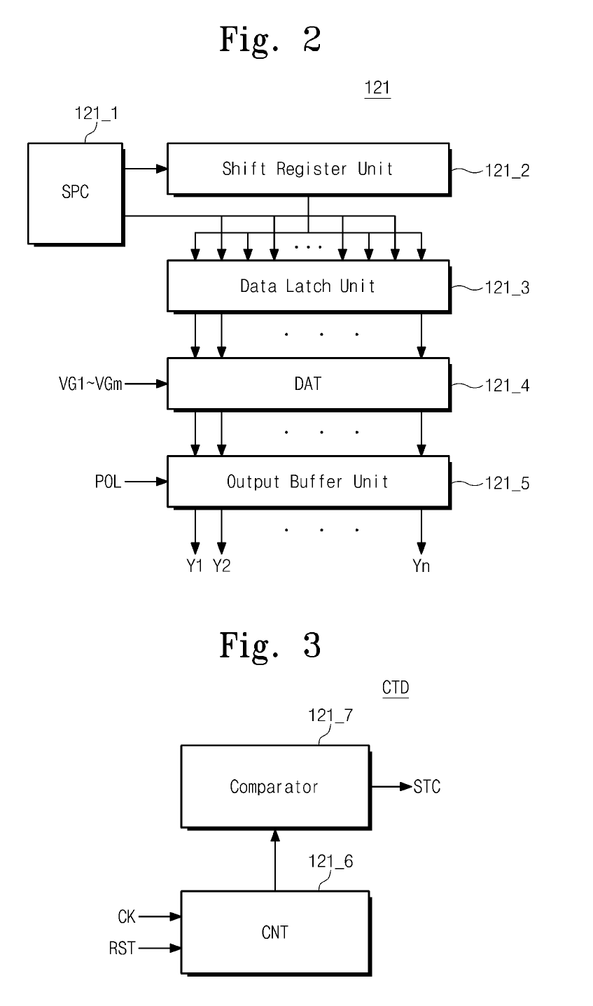

FIG. 2 is a block diagram schematically illustrating source driver 121 of the display device 100 of FIG. 1. Referring to FIG. 2, the source driver 121 may include a serial-to-parallel converter (SPC) 121_1, a shift register unit 121_2, a data latch unit 121_3, a digital-to-analog converter 121_4, and an output buffer unit 121_5.

The serial-to-parallel converter (SPC) 121_1 may receive at least one clock signal and image data in a low voltage differential signaling manner to convert it into parallel image data.

The shift register unit 121_2 may sequentially shift a clock signal provided from the serial-to-parallel converter 121_1. Herein, the clock signal may be used to synchronize an output of the shift register unit 121_2.

The data latch unit 121_3 may include a plurality of latch circuits (not illustrated). Each latch circuit may receive a clock signal from the shift register unit 121_2 and parallelized RGB data from the serial-to-parallel converter 121_1. That is, the data latch unit 121_2 may store parallelized RGB data sequentially from one end of the latch circuits until the other end thereof, based on shifted clocks of the clock signal.

The digital-to-analog converter 121_4 may transform the parallelized RGB data stored at the data latch unit 121_2 into analog data (or, referred to as gray scale voltages) using gamma reference voltages VG1 to VGm (m being a natural number). The digital-to-analog converter 121_4 may alternately output positive and negative voltages corresponding to the converted analog data in response to a polarity signal POL. Herein, the positive voltage may be higher than a reference voltage, and the negative voltage may be lower than the reference voltage.

The output buffer unit 121_5 may include a plurality of output buffers (not illustrated). Each of the output buffers may output the analog data Y1 through Yn converted by the digital-to-analog converter 121_4 to a pixel corresponding to an image data signal.

According to an embodiment, each output buffer may have a 2-channel driving structure.

FIG. 3 is a block diagram schematically illustrating a carry information transfer device CTD of the display device 100 of FIG. 1. Referring to FIG. 3, the carry information transfer device CTD may include a counter 121_6 and a comparator 121_7.

The counter 121_6 may be reset by a reset signal RST, and may perform a count operation in response to a clock signal CK. Here, the reset signal RST may be generated when a packet data is transferred from a timing controller 140 (refer to FIG. 1).

The comparator 121_7 may compare an output value of the counter 121_6 with a reference value to generate an output start-end signal STC. Herein, the reference value may correspond to a weight value included in a data packet provided from the timing controller 140.

The carry information transfer device CTD may generate the output start-end signal STC after a count operation corresponding to the weight value is performed.

FIG. 4 is a diagram illustrating a timing of an image data signal output from a display device in FIG. 1. Referring to FIG. 4, after image data signals Y_SD1 may be sequentially output from a first source driver 121 in response to a clock signal CLK, image data signals Y_SD2 may be sequentially output from a second source driver 122. After the image data signals Y_SD2 are sequentially output from the second source driver 122, image data signals Y_SD3 may be sequentially output from a third source driver 123. After image data signals Y_SD3 are sequentially output from a third source driver 123, image data signals Y_SD4 may be sequentially output from a fourth source driver 124.

As illustrated in FIG. 4, output start points of time of image data signals Y_SD1, Y_SD2, Y_SD3, and Y_SD4 of the source drivers 121 to 124 may be sequential. Thus, a peak current Ipeak generated when image data is output may be constant from an output start point of time of image data signals of the first source driver 121 until an output start point of time of image data signals of the fourth source driver 124. Compared with a peak current Ipeak of a conventional display device (marked by a dotted line), a peak current Ipeak of the display device 100 of the inventive concept (marked by a solid line) may be reduced.

Further, as illustrated in FIG. 4, output end points of time of the image data signals Y_SD1, Y_SD2, Y_SD3, and Y_SD4 of the source drivers 121 to 124 may be sequential.

Gate control signals GS_n provided to an nth gate line may output to correspond to the image data signals Y_SD1, Y_SD2, Y_SD3, and Y_SD4 dispersedly output in response to the clock signal CLK. As output start and end points of time of the image data signals Y_SD1, Y_SD2, Y_SD3, and Y_SD4 are sequential, an additional charging time ACT on the gate control signals GS_n may be secured. Gate control signals GS_n+1 provided to an (n+1)th gate line may not be output when the gate control signals GS_n are output, and may be output when the gate control signals GS_n are not output.

In FIG. 4, “CTL” may indicate a charge loss time from a time when the gate control signals GS_n are ended, until a time when gate control signals GS_n+1 start to be output.

With the timing control method of the display device 100 of the inventive concept, it is possible to reduce a peak current and to secure a sufficient charge time, by sequentially outputting the image data signals Y_SD1, Y_SD2, Y_SD3, and Y_SD4 of the source drivers 121 to 124.

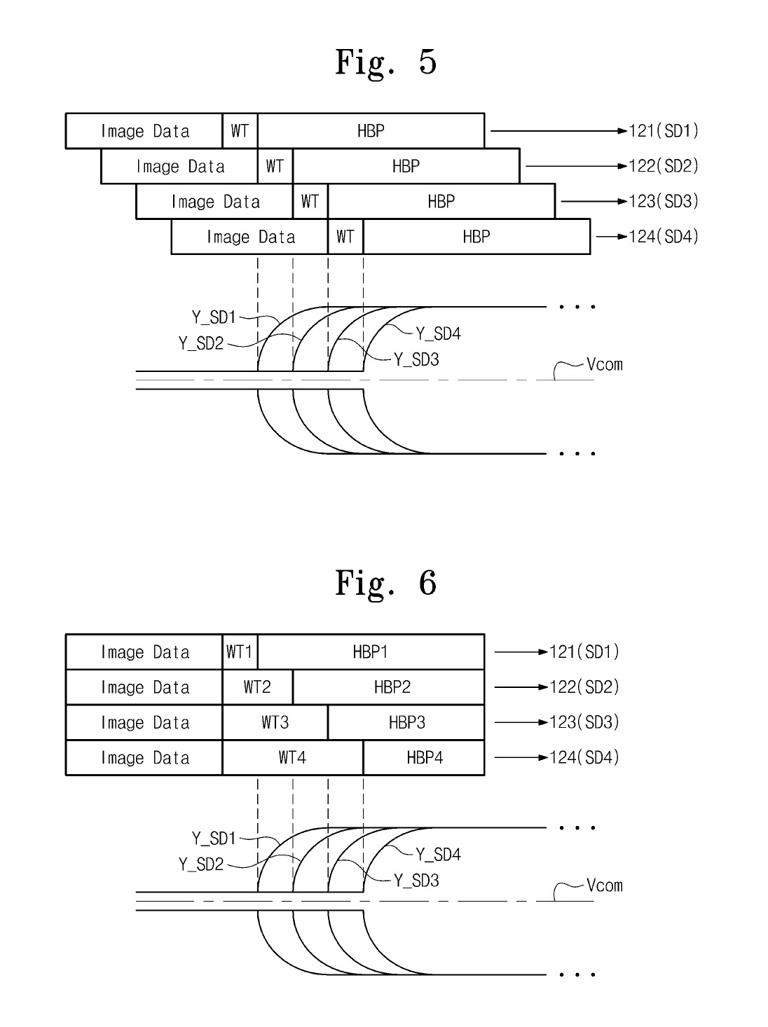

FIG. 5 is a diagram illustrating a data packet output from a timing controller 140 of the display device 100 of FIG. 1 according to an embodiment of the inventive concept. Referring to FIG. 5, the timing controller 140 may sequentially transfer data packets to source drivers 121 to 124. Each data packet may include the same weight value WT and the same horizontal blank period HBP. That is, each of the source drivers 121 to 124 may be configured to receive a data packet having image data, to perform a count operation, and to output image data signals Y_SD1, Y_SD2, Y_SD3, and Y_SD4.

For example, a first source driver 121 may receive a first data packet to be output to an nth gate line, perform a count operation corresponding to a weight value WT, output image data signals Y_SD1, and provide a second source driver 122 with first weight counting complete information.

The second source driver 122 may receive a second data packet output to the nth gate line and the first weight counting complete information from the first source driver 121, output image data signals Y_SD2 after performing a count operation corresponding to a weight value WT from a time when the first weight counting complete information is received, and provide a third source driver 123 with second weight counting complete information.

The third source driver 123 may receive a third data packet output to the nth gate line and the second weight counting complete information from the second source driver 122, output image data signals Y_SD3 after performing a count operation corresponding to a weight value WT from a time when the second weight counting complete information is received, and provide a fourth source driver 124 with third weight counting complete information. The fourth source driver 124 may receive a fourth data packet output to the nth gate line and the third weight counting complete information from the third source driver 123 and output image data signals Y_SD4 after performing a count operation corresponding to a weight value WT from a time when the third weight counting complete information is received.

Each of the source drivers 121 to 124 may output image data signals after performing a count operation corresponding to a weight value WT from a time when weight counting complete information is received from an adjacent source driver.

FIG. 6 is a diagram illustrating a data packet output from the timing controller 140 of the display device 100 of FIG. 1 according to an embodiment of the inventive concept. Referring to FIG. 6, the timing controller 140 may transfer data packets to source drivers 121 to 124 at the same time. The data packets may include different weight values WT1 to WT4 and different horizontal blank periods HBP1 to HBP4. That is, the source drivers 121 to 124 may be configured to receive a data packet having image data, to perform a count operation, and to output image data signals Y_SD1, Y_SD2, Y_SD3, and Y_SD4 after performing count operations corresponding to corresponding weight values WT1 to WT4.

For example, a first source driver 121 may receive a first data packet output to an nth gate line, output image data signals Y_SD1 after performing a count operation corresponding to a first weight value WT1, and provide a second source driver 122 with first weight counting complete information. The second source driver 122 may receive a second data packet output to the nth gate line and the first weight counting complete information from the first source driver 121, output image data signals Y_SD2 after performing a count operation corresponding to a second weight value WT2 from a time when the first weight counting complete information is received, and provide a third source driver 123 with second weight counting complete information.

The third source driver 123 may receive a third data packet output to the nth gate line and the second weight counting complete information from the second source driver 122, output image data signals Y_SD3 after performing a count operation corresponding to a third weight value WT3 from a time when the second weight counting complete information is received, and provide a fourth source driver 124 with third weight counting complete information. The fourth source driver 124 may receive a fourth data packet output to the nth gate line and the third weight counting complete information from the third source driver 123, output image data signals Y_SD4 after performing a count operation corresponding to a fourth weight value WT4 from a time when the third weight counting complete information is received.

To sequentially output image data signals, the source drivers 121 to 124 may perform count operations corresponding to different weight values from a time when the corresponding counting complete information is received from an adjacent source driver.

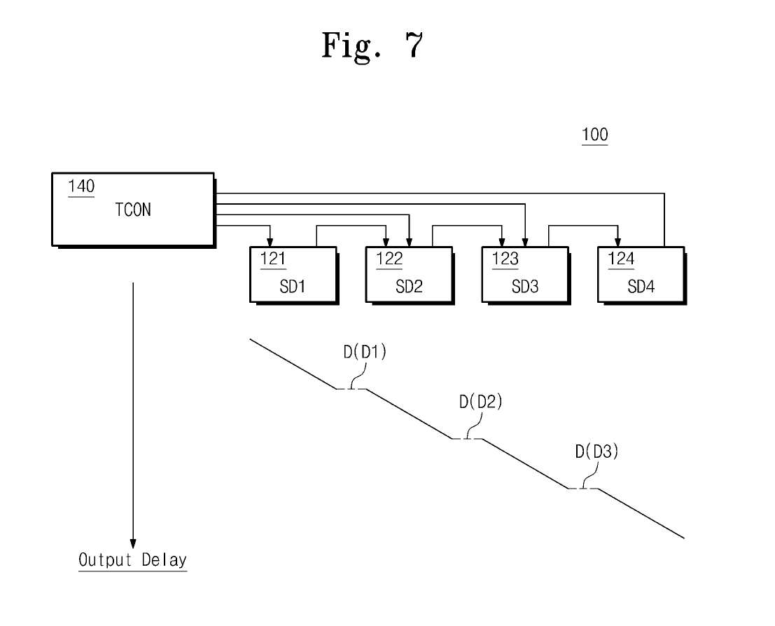

FIG. 7 is a diagram schematically illustrating an output shape (output pattern) 100a of an image data signal in the display device 100 of FIG. 1. Referring to FIG. 7, an image data signal may be delayed by a period D and output by each of source drivers 121 to 124. In addition, the image data signal may start to be output according to carry information transferred from an adjacent source driver. Herein, the carry information may indicate that all image data signals corresponding to an nth gate line start to be output from an adjacent source driver.

FIG. 7 illustrates an output shape (pattern) 100a of the image data signal as an example. However, the inventive concept is not limited thereto. It is possible that the display device 100 of the inventive concept may be configured such that an output of the image data signal is started according to carry information transferred from an adjacent source driver and the image data signal is output by various shapes (patterns).

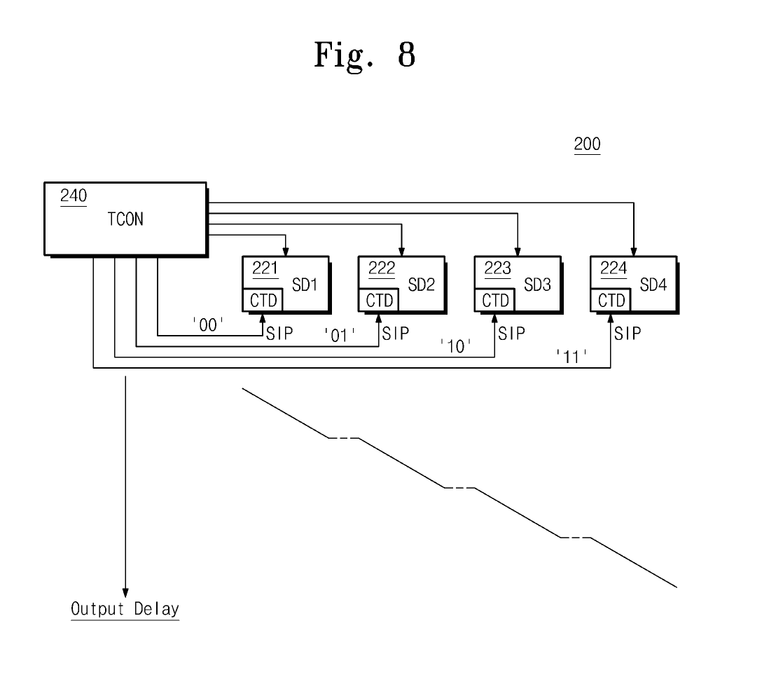

FIG. 8 is a block diagram schematically illustrating a display device 200 according to an embodiment of the inventive concept. Referring to FIG. 8, output delay information of an image data signal may be transferred between a timing controller and source drivers 221 to 224. Each of the source drivers 221 to 224 may include a signal information pin SIP for receiving the output delay information.

For example, a first source driver 221 may receive output delay information of ‘00’, a second source driver 222 may receive output delay information of ‘01’, a third source driver 223 may receive output delay information of ‘10’, and a fourth source driver 224 may receive output delay information of ‘11’. Each of the source drivers 221 to 224 may delay an image data signal according to the input output delay information. The image data signal may be output as illustrated in FIG. 8.

The display device 200 of the inventive concept may delay an output point of time of an image data signal based on input output delay information.

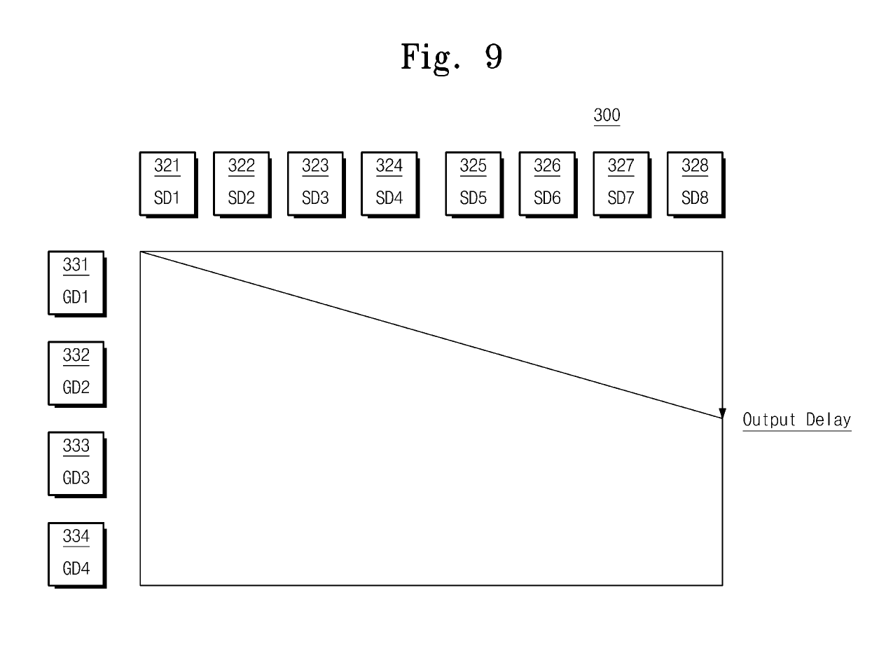

FIG. 9 is a block diagram schematically illustrating a display device 300 according to an embodiment of the inventive concept. In FIG. 9, a display device 300 may have a single bank gate. Referring to FIG. 9, the display device 300 may include eight source drivers 321 to 328 and four gate drivers 331 to 334.

The display device 300 may configured to sequentially delay image data signals to be provided to source lines and to sequentially delay output start points of time of image data signals based on carry information transferred from an adjacent source driver. Also, as illustrated in FIG. 9, gate lines corresponding to first and second gate drivers 331 and 332 may be sequentially driven. FIG. 9 illustrates eight source drivers 321 through 328 and gate drivers 331 through 334, for example.

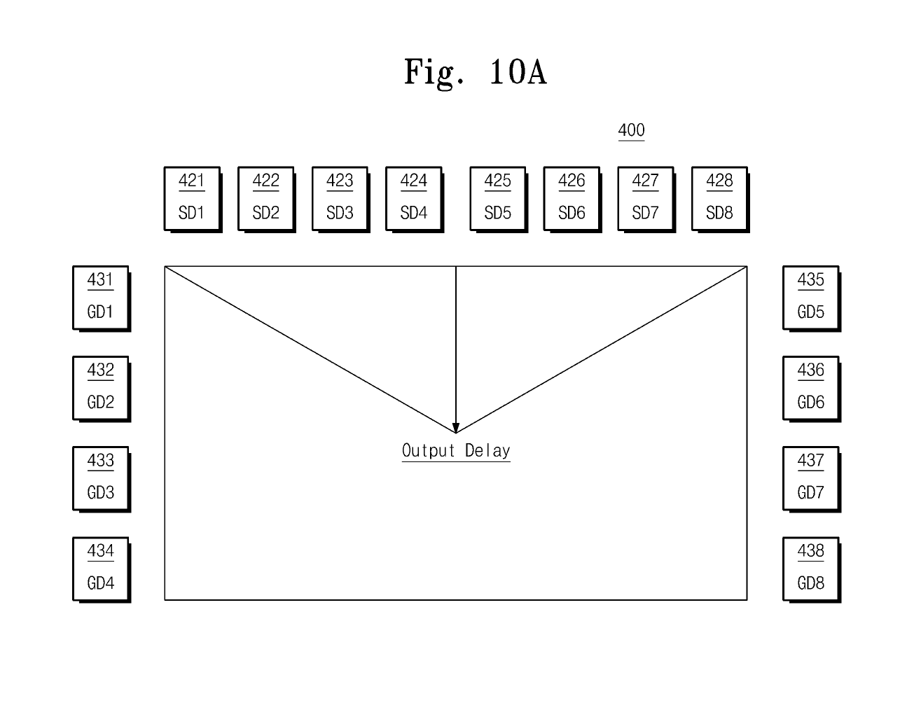

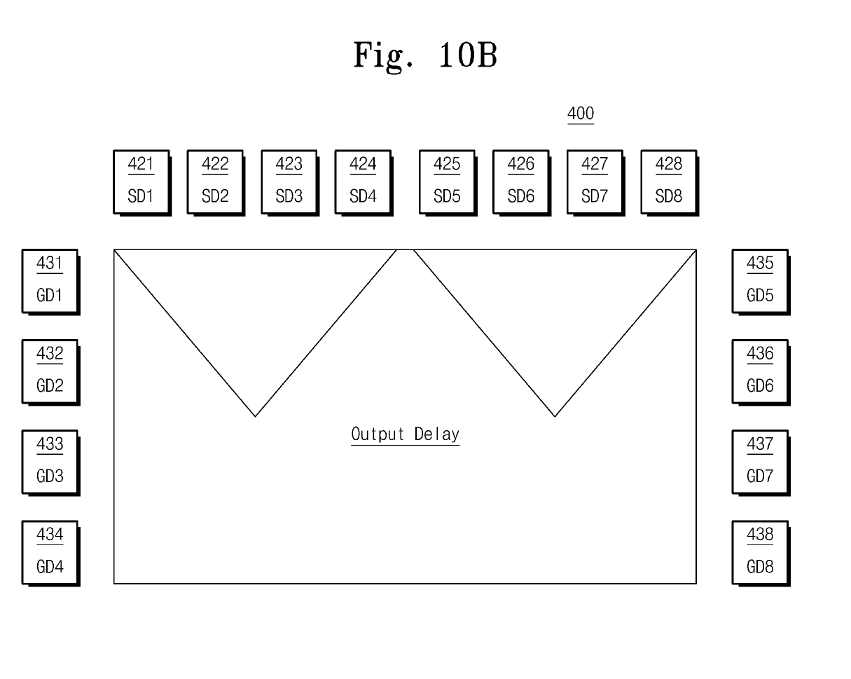

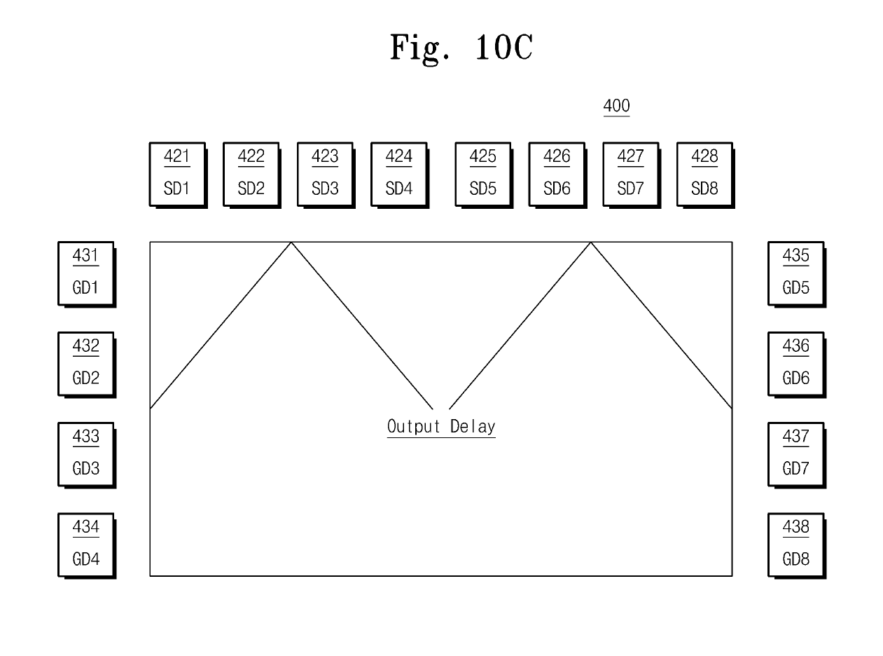

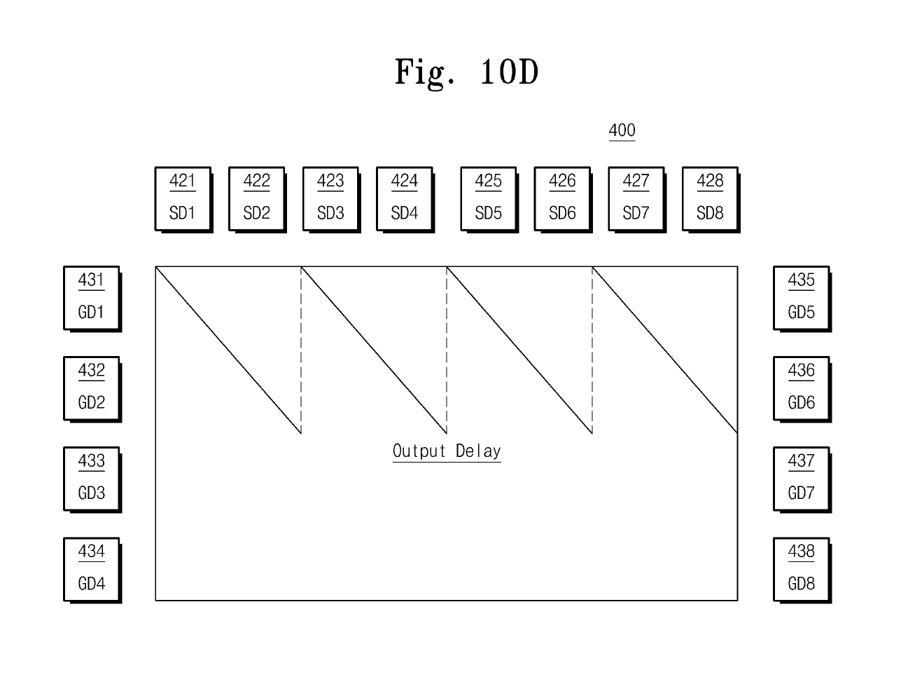

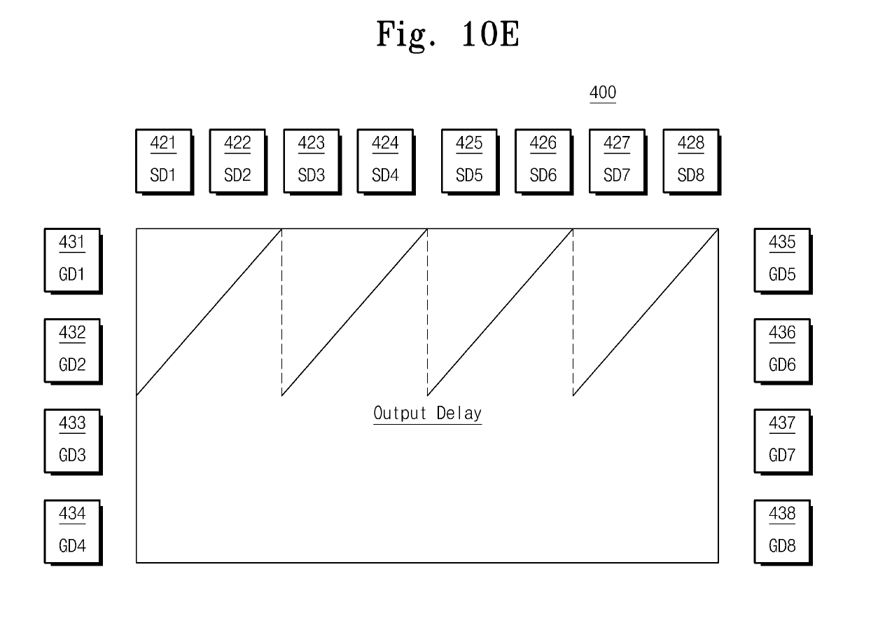

FIGS. 10A to 10E are diagrams illustrating a display device 400 having output shapes (patterns) of an image data signal in a display device having a double bank gate according to an embodiment of the inventive concept.

Referring to FIG. 10A, the display device 400 may include eight source drivers 421 to 328, four gate drivers 431 to 434 disposed at a left side of a panel, and four gate drivers 435 to 438 disposed at a right side of a panel as a double back gate structure. However, the inventive concept is not limited thereto.

The display device 400 may sequentially delay output start points of time of image data signals at the source drivers 421 to 424. The display device 400 may delay image data signals from the source drivers 425 to 428 to be symmetrical to those from the source drivers 421 to 424.

Also, as illustrated in FIG. 10A, gate lines corresponding to first and second gate drivers 431 and 432 may be sequentially driven. Gate lines corresponding to fifth and sixth gate drivers 435 and 436 symmetrically placed may be driven to be symmetrical to those corresponding to the first and second gate drivers 431 and 432.

Shapes (patterns) of delayed output signals may be various. For example, as illustrated in FIGS. 10B and 10C, output signals may be delayed to have a chopping wave shape. Alternatively, as illustrated in FIGS. 10D and 10E, output signals may be delayed to have a saw wave shape.

Each of the source drivers 421 to 428 may output delayed signals sequentially. However, an output signal shape of each source driver is not limited to this disclosure. Various output signal shapes of the source drivers 421 to 428 are disclosed in U.S. Patent Publication No. 2009/0058838, the entirety of which is herein incorporated by reference.

In FIGS. 1 to 10, the timing controller 140 may be configured to control a plurality of source drivers through separate data lines. However, the inventive concept is not limited thereto. The timing controller 140 can be configured to control a plurality of source drivers through shared data lines.

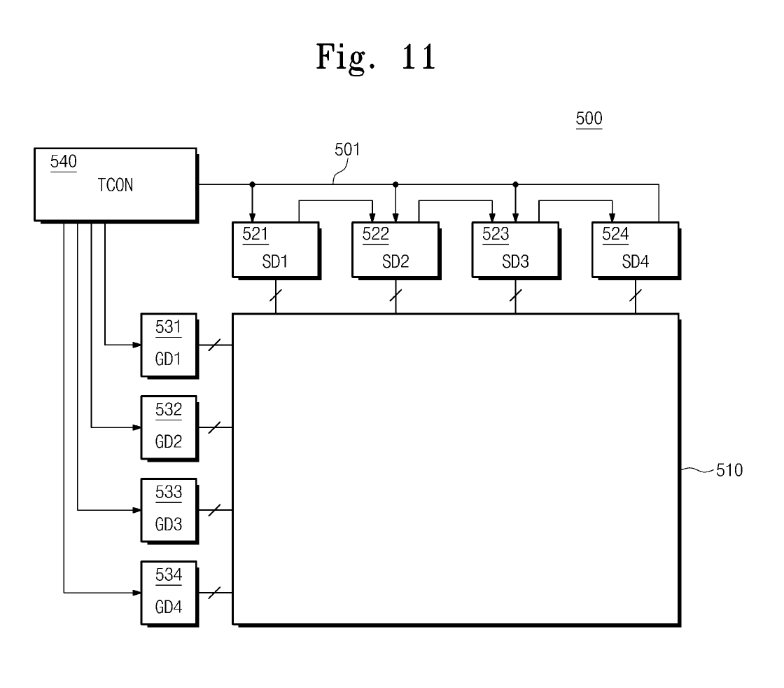

FIG. 11 is a block diagram schematically illustrating a display device 500 according to an embodiment of the inventive concept. Referring to FIG. 11, the display device 500 may include a display panel 510, a plurality of source drivers 521 to 524, a plurality of gate drivers 531 to 534, and a timing controller 540. The timing controller 540 may transfer image data to the source drivers 521 to 524 through a shared data line 501.

In case of a display device 100 in FIG. 1, carry information may be propagated from a first source driver 121. However, the inventive concept is not limited thereto. For example, carry information can be propagated from at least one of source drivers.

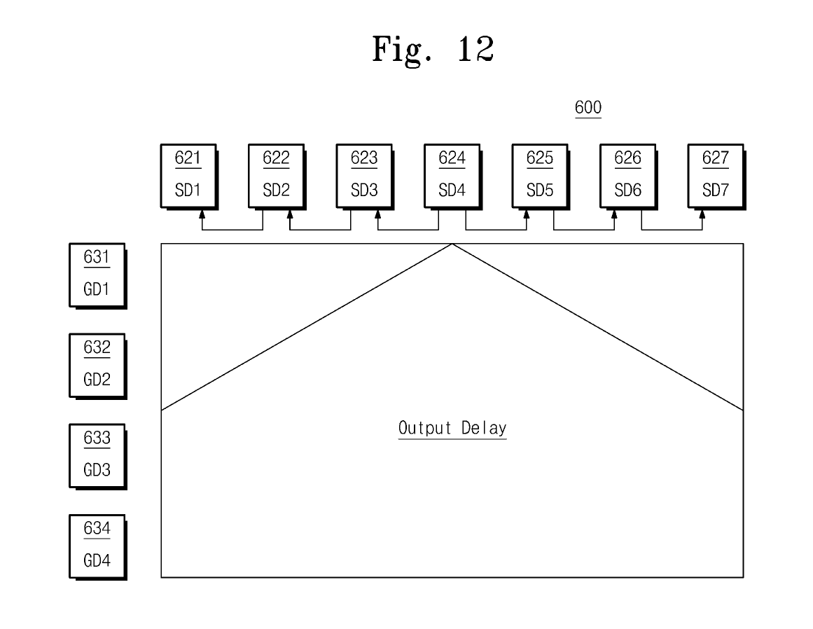

FIG. 12 is a block diagram schematically illustrating a display device 600 according to an embodiment of the inventive concept. Referring to FIG. 12, the display device 600 may include a plurality of source drivers 621 to 627 and a plurality of gate drivers 631 to 634. Propagation of carry information may be started from a fourth source driver 624. That is, propagation of carry information may be divided into first carry information propagation performed toward a left side of the fourth source driver 624 and second carry information propagation performed toward a right side of the fourth source driver 624. Herein, the first carry information propagation and the second carry information propagation may be performed at the same time.

With the first carry information propagation, signals may be first output from the fourth source driver 624. Signals may be output from a third source driver 623 based on carry information of the fourth source driver 624. Signals may be output from a second source driver 622 based on carry information of the third source driver 623. Signals may be output from a first source driver 621 based on carry information of the second source driver 622.

Likewise, with the second carry information propagation, signals may be first output from the fourth source driver 624. Signals may be output from a fifth source driver 625 based on carry information of the fourth source driver 624. Signals may be output from a sixth source driver 626 based on carry information of the fifth source driver 625. Signals may be output from a seventh source driver 627 based on carry information of the sixth source driver 622.

The display device 600 in FIG. 12 may be configured to propagate carry information toward both sides from the source driver 624 placed at a center.

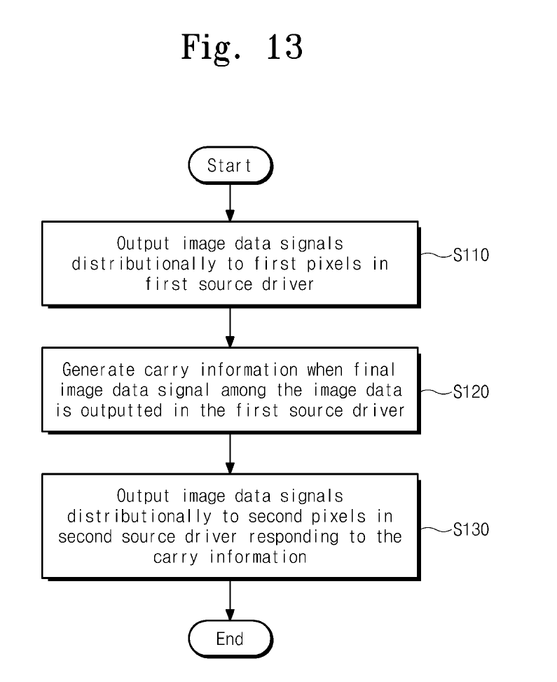

FIG. 13 is a flowchart illustrating a data output method of a display device according to an embodiment of the inventive concept.

Referring to FIG. 13, a first source driver may dispersedly output image data signals to first pixels connected with a gate line at operation S110. When the last image data signal of the image data signals is output, the first source driver may generate carry information at operation S120. Herein, the carry information may indicate that all image data signals start to be output from the first source driver. The second source driver may dispersedly output image data signals to second pixels connected with a gate line in response to the carry information at operation S130.

With the data output method of the inventive concept, it is possible to dispersedly output image data signals in response to carry information of an adjacent source driver.

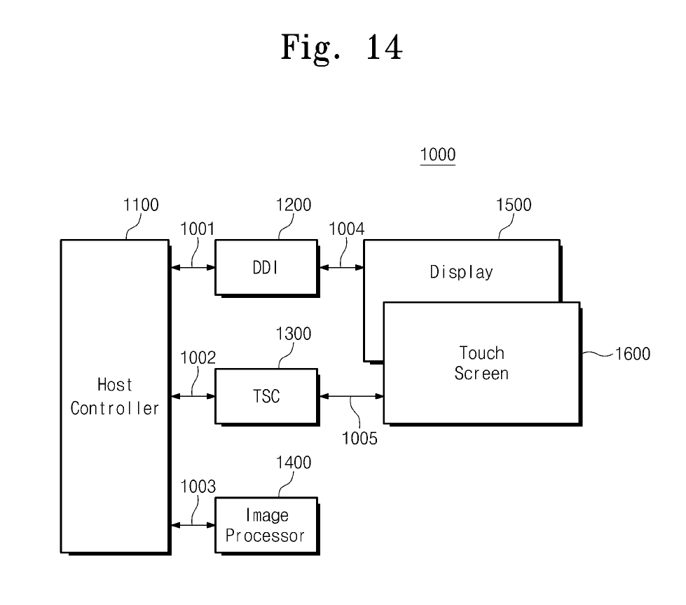

FIG. 14 is a block diagram schematically illustrating a data processing system 1000 having a display device according to an embodiment of the inventive concept. Referring to FIG. 14, the data processing system 1000 may include a host controller 1100, a display driver integrated circuit (DDI) 1200, a touch screen controller (TSC) 1300, and an image processor 1400. The display driver integrated circuit 1200 may be configured to provide a display 1500 with display data 1004. The touch screen controller 1300 may be connected with a touch panel 1600 disposed to correspond to the display 1500, and may be configured to receive sense data 1005 from the touch panel 1600. The display driver integrated circuit 1200 according to the inventive concept may be configured to dispersedly output image data signals in response to carry information of an adjacent source driver. The display device 500 may be one of display devices 100 through 600 illustrated in FIGS. 1 through 12

The data processing system 1000 is in detail disclosed in U.S. Patent Publication No. 2010/0241957, the entirety of which is herein incorporated by reference.

The data processing system 1000 is applicable to mobile phones (e.g., Galaxy S, iPhone, etc.), tablet PCs (e.g., Galaxy tab, iPad, etc.), and the like.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A display device, comprising:
a display panel having pixels arranged at intersections of source lines and gate lines;
a plurality of source drivers configured to dispersedly output image data signals to the source lines in response to source control signals and a data packet;
a plurality of gate drivers configured to drive gate lines in response to gate control signals so as to be connected with pixels corresponding to the source lines; and
a timing controller configured to output the data packet, the source control signals, and the gate control signals,
wherein at least one of the plurality of source drivers is configured to output carry information associated with an output of the image data signals, and at least another of the plurality of source drivers is configured to output the image data signals in response to the carry information.

2. The display device of claim 1, wherein each of the pixels comprises:
a thin film transistor connecting one of the source lines and a pixel node in response to one of the gate control signals;
a liquid crystal capacitor connected between the pixel node and a common node and having a liquid crystal layer adjusting a penetration ratio according to a voltage difference; and
a storage capacitor connected between the pixel node and the common electrode.

3. The display device of claim 1, wherein the timing controller sequentially drives the gate lines.

4. The display device of claim 3, wherein each of the plurality of source drivers sequentially output image data signals.

5. The display device of claim 4, wherein the at least one source driver generates the carry information when a last image data signal is output.

6. The display device of claim 4, wherein each of the plurality of source drivers sequentially outputs the image data signals in response to a clock and sequentially blocks the image data signals in response to a next clock.

7. The display device of claim 1, wherein the at least one source driver includes a carry information transfer device which generates the carry information to transfer the carry information to the at least another source driver.

8. The display device of claim 7, wherein:
the data packet includes a weight value; and
the plurality of source drivers receives data packets each having the same weight value, respectively, and outputs image data signals after performing a count operation corresponding to the weight value.

9. The display device of claim 7, wherein:
the data packet includes a weight value; and
the plurality of source drivers receives data packets having different weight values and outputs image data signals after performing a count operation corresponding to a corresponding weight value.

10. The display device of claim 1, wherein the timing controller is connected to the plurality of source drivers to transfer the source control signals and the data packet.

11. The display device of claim 10, wherein each of the plurality of source drivers further includes a signal information pin receiving directing an output order of the source drivers.

12. The display device of claim 1, wherein the plurality of gate drivers is disposed at one side of the display panel.

13. The display device of claim 2, wherein the plurality of gate drivers is disposed at one side of the display panel and another side opposite to the one side.

14. An image data signal output method of a display device, the method comprising:
dispersedly outputting image data signals to first pixels from a first source driver;
generating carry information when image data signals start to be output from the first source driver; and
dispersedly outputting image data signals to second pixels from a second source driver in response to the carry information.

15. The image data signal output method of claim 14, wherein the generating carry information includes generating the carry information after a count operation corresponding to a weight value of the first source driver is performed.

16. A non-transitory computer-readable medium to contain computer-readable codes as a program to execute the method of claim 14.

17. A display device usable with a data processing system, comprising:
a display panel; and
a plurality of drivers each to drive a corresponding different group of pixels of the display panel,
wherein one driver outputs carry information to an adjacent driver such that the adjacent driver drives the corresponding group of pixels according to the received carry information.

18. The display device of claim 17, wherein the one driver drives the corresponding group of pixels of the display panel without using the carry information, and the adjacent driver drives the corresponding group of pixels using the carry information.

19. The display device of claim 17, further comprising:
one or more gate drivers each to drive a corresponding portion of the different group of pixels of the display panel regardless of the carry information or independent of the carry information.

20. The display device of claim 17, further comprising:
a timing controller to control the drivers such that a current peak is lowered in driving the display panel.

21. (canceled)
